(19) United States
(12) Patent Application Publication
(10) Pub. No.: US 2026/0270946 A1
(43) Pub. Date: Sep. 10, 2026

(54) MULTI-MODAL SENSOR INFORMATION FOR LOCALIZATION

(71) Applicant: Unknot.id Inc., Winter Garden, FL (US)

(72) Inventors: Michael Park, Cresskill, NJ (US); Shubham Kedia, Winter Garden, FL (US); Michael Gerber, Winter Garden, FL (US); Warren Snipes, Winter Garden, FL (US); Devu Manikantan Shila, Winter Garden, FL (US)

(21) Appl. No.: 19/557,853

(22) Filed: Mar. 5, 2026

Related U.S. Application Data
(60) Provisional application No. 63/767,266, filed on Mar. 5, 2025.

(51) Int. Cl. H04W 64/00

(52) U.S. Cl. CPC H04W 64/00

(57) ABSTRACT

The present disclosure provides systems and methods of predicting a location of a primary device within an environment is provided. A relative motion signal is obtained from the primary device. Data is obtained from a plurality of non-network communication devices. A location of each of the plurality of non-network communication devices is determined with respect to the primary device. A position of the primary device within the environment is computed via a machine learning model based on the relative motion signal and the location of each of the plurality of non-network communication devices. The computed position of the primary device within the environment is outputted.

### CROSS-REFERENCE TO RELATED APPLICATIONS

This application claims priority to U.S. Application No. 63/767,266, titled “MULTI-MODAL SENSOR INFORMATION FOR LOCALIZATION,” filed Mar. 5, 2025, which is hereby incorporated by reference in its entirety.

### BACKGROUND

Complexes such as airports and casinos often comprise several buildings and areas, spanning across a large geographical space. In these complexes, three-dimensional localization of objects within the environments is often difficult due to high error areas, and installation of security systems throughout can be time consuming and costly. For example, global position system (GPS) data obtained from within these complexes is often very noisy or not available at all. Moreover, installing infrastructure may be difficult due to ceiling height and associated installation costs.

Therefore, there is a need for improved systems and methods for performing localization in complex environments.

### SUMMARY OF THE DISCLOSURE

The present disclosure overcomes the aforementioned drawbacks by providing systems and methods for performing localization via multiple modal sensors.

In accordance with one aspect of the present disclosure, a method of predicting a location of a primary device within an environment is provided. A relative motion signal can be obtained from the primary device. Data can be obtained from a plurality of non-network communication devices. A location of each of the plurality of non-network communication devices can be determined with respect to the primary device. A position of the primary device within the environment can be computed via a machine learning model based on the relative motion signal and the location of each of the plurality of non-network communication devices. The computed position of the primary device within the environment can be outputted.

In another aspect of the present disclosure, a system for producing a location of a primary device within an environment is provided. The system can include a plurality of non-networked devices, a processor, and an electronic controller connected to the processor. The electronic controller can include a memory with instructions stored therefore that, when executed, cause the electronic controller to obtain data from the plurality of non-networked devices. A location of each of the plurality of non-networked devices can be determined with respect to the primary device. A position of the primary device within the environment can be computed based on the data obtained from the plurality of non-networked devices and the location of each of the plurality of non-networked devices. The computed position of the primary device within the environment can be outputted.

In another aspect of the present disclosure, a system for localizing a device within a building complex is provided. The system can include a primary device including one or more relative motion sensors, a plurality of non-network communication devices, and a computing device. The computing device can be configured to obtain a relative motion signal from the primary device. Data can be obtained from the plurality of non-network communication devices. A location of each of the plurality of non-network communication devices can be determined with respect to the primary device. A position of the primary device within the building complex can be computed using the relative motion signal, the data from the plurality of non-network communication devices, and the determined locations of the plurality of non-network communication devices.

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 illustrates a block diagram of a localization system, according to some aspects of the present disclosure.

FIG. 2 illustrates a server system for performing localization, according to some aspects of the present disclosure.

FIG. 3 illustrates a flowchart of a process for performing localization, according to some aspects of the present disclosure.

FIG. 4 illustrates an example flow diagram illustrating an overview of a creation of a spatial fingerprint, according to some aspects of the present disclosure.

### DETAILED DESCRIPTION OF THE PRESENT DISCLOSURE

The present disclosure provides systems and methods that can localize an object of interest using both sensors internal to the object, as well as information gather from nearby static and mobile devices or assets. That is, systems and methods are provided herein for localization of both the object of interest, as well as the object around it. In one non-limiting example, the systems and methods provided herein may be used to predict an object's three-dimensional (3D) position within an environment. The systems and methods provided herein will be described with reference to the figures, forming an instrumental yet non-limiting reduction to practice of the specification.

To localize an object of interest, one or more heterogeneous sensors in smart devices may be used, which may include various sets of sensors and sampling rates. Moreover, contextual information from the environment may also be used, such as static objects (e.g., access control systems and CCTV cameras), and mobile objects (e.g., smartphones, wearable devices, and asset trackers) to predict the object's 3D position. In some examples, the systems and methods provided herein may be used to predict the object's latitude, longitude, elevation, speed, and/or direction.

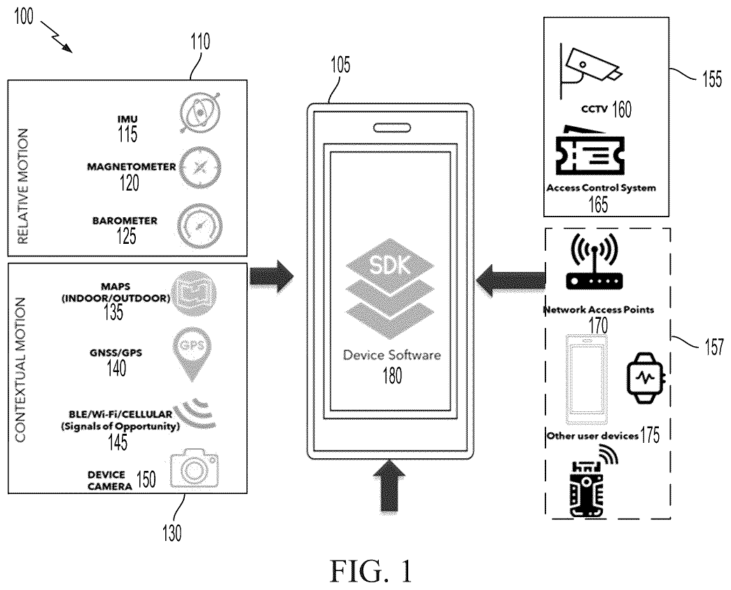

FIG. 1 illustrates a block diagram of a localization system 100 for localizing a primary device 105. In some examples, the primary device 105 can be an electronic device such as a smartphone, a smart radio, panic or emergency assistance buttons, smart badges, laptops, asset trackers, or a wearable device. Moreover, in some examples, the primary device 105 can be an object, asset, or item. The primary device 105 can include one or more relative motion sensors 110. The one or more relative motion sensors may be internal to the primary device 105, may have a wired connection with the primary device 105, or may be connected wirelessly. In some examples, the one or more relative motion sensors 110 can include an inertial measurement unit (IMU) 115, a magnetometer 120, and/or a barometer 125. In examples, data from the relative motion sensors 110 may be collected upon the passing of a predefined interview (e.g., every 1 second, every 5 seconds, every 6 seconds, etc.). In further examples, one or more predefined events may trigger the collection of data via the relative motion sensors 110. For example, a user may press . a panic or emergency assistance button, or a user may send in inquiry regarding one or more locations of an employee and/or asset. In some examples, the barometer may be used to determine altitude change information of the primary device 105. For example, the barometer readings may allow the system 100 to determine a level change due to the device 105 moving up/down stairs, elevators, or escalators. The IMU 115 can include an accelerometer and/or a gyroscope. The primary device 105 can further include one or more contextual motion readings 130. In some examples, the one or more contextual motion readings 130 can include a map 135, a global positioning system (GPS) signal 140, a wi-fi or cellular connection 145, a camera or video input 150, a Bluetooth connection, an audio input, a pedometer, a light level, a LiDAR signal, and/or a battery status.

The primary device 105 may include a memory and an electronic processor for storing both signals received from the one or more relative motion sensors 110, as well as the one or more contextual motion readings 130. The electronic processor, the memory, and the sensors/readings may communicate over one or more control and/or data buses of the primary device 105. The memory may include read-only memory (ROM), random access memory (RAM), other non-transitory computer-readable media, or a combination thereof. Moreover, the electronic processor may be configured to communicate with the memory to store data and retrieve stored data. The electronic processor may be configured to receive instructions corresponding to the processing of specific sensors or readings.

As illustrated in FIG. 1, the localization system 100 further includes one or more non-network communication devices 155. In some examples, the one or more non-network communication devices 155 can include closed system devices, such as a networked closed-circuit television (CCTV) 160 or a networked access control system 165. In some examples, an organization operating the CCTV 160 or the networked access control system 165 may provide a registration to the one or more non-network communication device 155 for the transmission of data. A vendor or organization corresponding to a closed system can provide databases collected from devices in the corresponding closed system. In some examples, the data provided may be pre-processed. For example, the vendor or organization operating a closed-circuit television (CCTV) may provide data such as images or video to the device software 180. In some examples, the one or more non-network communication devices 155 may exclude devices and systems containing open-system signals, such access points, routers, GPS signals, Bluetooth devices, Wi-Fi hotspots, cell tower locations, and the like.

In some examples, the localization system 100 can optionally include one or more network communication protocols 157, such as devices and signals associated with one or more networked access points 170, and/or one or more networked signals 175 from other devices or objects within an environment.

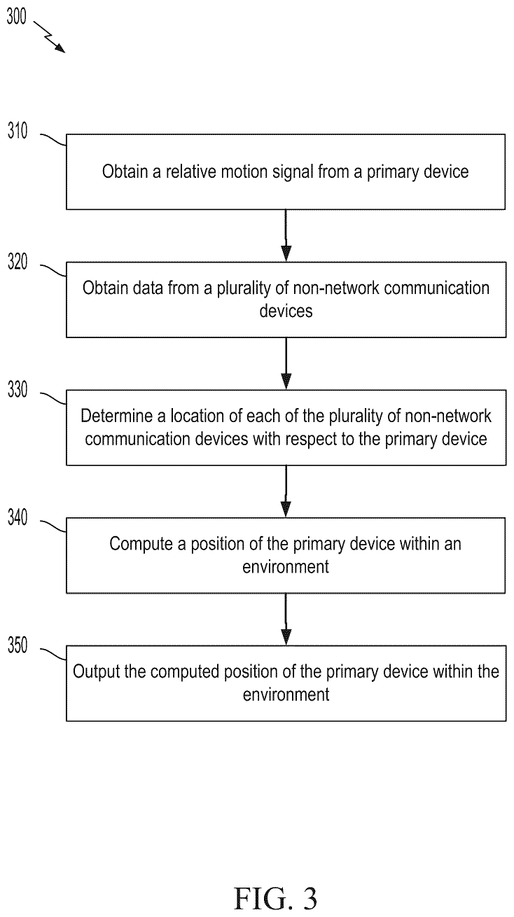

The primary device 105 may further include a mobile application or device software 180. In some examples, the device software 180 may be installed by a user of the primary device 105. The device software 180 may obtain or receive real-time readings of the one or more relative motion sensors 110. In some examples, the motion sensors 110 may be internal to the primary device 105. Each motion sensor in the one or more motion sensors 110 may collect or sample data at different rates, therefore, in some examples, the primary device 105 may receive specific data readings at various rates, frequencies, and/or times. Once the readings are collected, the device software 180 may sync the readings in batches to a localization server, as described below with respect to FIG. 3. In some examples, the device software 180 may delete the readings locally once it is confirmed to have been received by the localization server. In further examples, the primary device 105 may perform localization without connecting to the one or more relative motion sensor 110, for example, using other connected device (e.g., contextual motion readings 130, non-network communication devices 155, and/or network communication protocols 157)

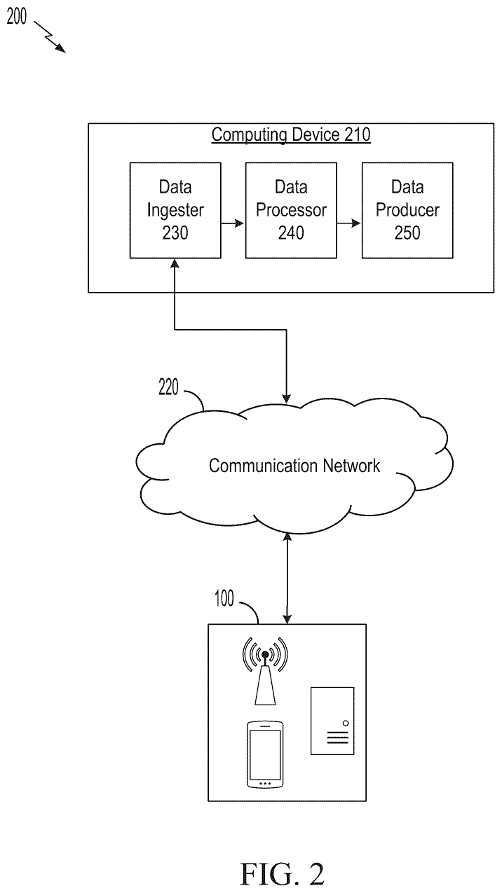

FIG. 2 shows a block diagram illustrating a server system 200 for performing localization, according to some embodiments. The server system 200 can include a computing device 210 that can receive data and information from the localization system 100 via a communication network 220. In some examples, the data utilized in the server system 200 may be private and be assigned random identifiers. The computing device 210 can be an integrated circuit (IC), a computing chip, or any suitable computing device. In some examples, the computing device 310 can be a special purpose device to implement the localization software. For example, computing device 210 may be implemented locally within the localization system 100. Alternatively, in some examples, the computing device 210 may be implemented on a remote server (i.e., via the Cloud).

In the system 200, a data ingester 230 within the computing device 210 can obtain or receive a dataset. In some examples, the dataset may include one or more signals obtained from the one or more contextual motion readings 130 and/or the one or more non-network communication device 155 via the communication network 220. The data ingester 230 may pre-process the signals within the dataset, and filter noises. For example, the dataset may include intervals of missing data, duplicate batches, or data that violates motion constraints, requiring the data ingester 230 to reconstruct data intervals. Moreover, the data ingester 230 may prepare a data package corresponding to the pre-processed dataset, which is transferred to a data processor 240.

The data processor 240 may be a multi-modal sensor processing and fusion system configured to exploit multiple machine learning techniques to process the data package received from the data ingester 230 For example, the fusion system may include a motion artificial intelligence (AI) model, a map AI model, a signal AI model, or a view AI model. The motion AI model may process inertial navigation data, such as data from an accelerometer, a gyroscope, a magnetometer, or the like. The map AI model may create information regarding the determination and correction of user's position by processing barometer, GPS data, and map data (i.e., two-or three-dimensional data). In some examples, the map AI model may be trained using image matching reinforcement. The signal AI model may process wireless data emitting from a Wi-Fi router, a Bluetooth signal, a GPS signal to create various radio maps. The view AI model may determine visual odometry based on images or videos received from a camera or the like. In some examples, the various AI models may provide determinations regarding the velocity, orientation, position, floor level, direction, etc., as well as corresponding uncertainties, which may be combined in the fusion system. Moreover, in further examples, one or more of the AI models may include a permutation-invariant neural network configured to process multiple signals, including a identity of a device in which the signal was obtained from. In some examples, the data package may include a stream of data corresponding to each sensor and/or reading obtained from the localization system 100. The data processor 240 can process each stream to predict information regarding the 3D position of the primary device 105. In some examples, the prediction produced by the data processor 240 can include a corresponding uncertainty, which may be determined based on confidence levels of each AI model.

Once a prediction is produced, the data processor 240 may pass the prediction to a data producer 250. The data producer 250 can output the prediction and the associated dataset. In some examples, the output may include a predicted location (i.e., latitude, longitude, floor level, elevation, etc.) and speed, as well as an associated device identification and/or timestamp. In some examples, the output may be received by a visualization application, such as a geographical JavaScript Object Notation (geoJSON) or as comma-separated values (CSV). In other examples, the output can include be transferred to a display to output a prediction indication. In some examples, a user receiving the output may request additional information or associated functionalities associated with the prediction, causing the computing device 210 to perform additional processing or collect the additional information via the communication network 220. In some embodiments, the display can include any suitable display devices, such as a computer monitor, a touchscreen, a television, an infotainment screen, etc. to display a prediction report, or any suitable result of a localization indication. In further examples, the prediction output can be transmitted to another system or device over the communication network 220.

FIG. 3 is a flow diagram illustrating an example process 300 for performing localization, in accordance with some aspects of the present disclosure. As described below, a particular implementation can omit some or all illustrated features/steps, may be implemented in some embodiments in a different order, and may not require some illustrated features to implement all embodiments. In some examples, an apparatus (e.g., localization system 100, server system 200) in connection with FIGS. 1 and 2 can be used to perform all or part of example process 300. However, it should be appreciated that other suitable devices for carrying out the operations or features described below may perform process 300.

At step 310, a relative motion signal is obtained from a primary device. In some examples, the primary device may correspond to primary device 105, as described above with respect to FIG. 1. For example, the primary device may include a smartphone, a smart radio, a wearable device, a walkie-talkie, or the like. In some examples, the relative motion signal may correspond to one or more inertial sensors of the primary device (i.e., signals from the one or more relative motion sensors 110). The inertial sensors may be housed on the primary device or be connected to the device via a wired or wireless connection.

The relative motion signal may be determined using the readings from the one or more inertial sensors, as well as any contextual information regarding the environment surrounding the primary device (i.e., from the one or more contextual motion readings 130). In some examples, the primary device may have software running thereon (i.e., device software 180) that creates a fingerprint of the environment around the primary device using a pretrained or crowd-sensed model. For example, the fingerprint may be a spatial fingerprint that records information regarding the environment the device at a given point in time. In some examples, multiple spatial fingerprints may be combined to determine the location of the device in the given environment (e.g., building, campus, floor, etc.).

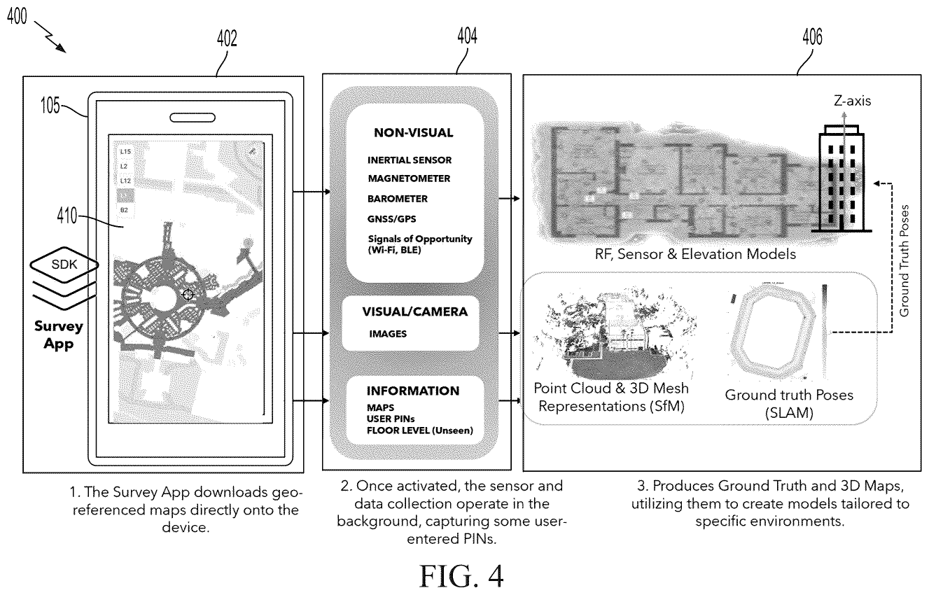

FIG. 4 illustrates an example flow diagram 400 of the creation of a spatial fingerprint. In particular, at block 402, a map 410 of an environment (e.g., building) may be obtained from an organization or vendor. The map 410 may be uploaded to an application running on the primary device 105. When the primary device 105 is detected as being located in the environment corresponding to the map 410, the application may collect data from the relative motion sensors 110, the contextual motion readings 130, the non-network communication device 155, and/or the network communication protocols 157 at block 404. In some examples, the application may further collect identification information from the relative motion sensors 110, the contextual motion readings 130, the non-network communication device 155, and/or the network communication protocols 157, such as a device identifier, a timestamp identifier, a session identifier, or the like. The spatial fingerprint may then be created at block 406 using the collected data and identification information.

The relative motion signal may be obtained directly from the primary device, or it may be obtained via the cloud. For example, the primary device may obtain real-time readings of one or more inertial sensors and automatically sync the readings, as well as the corresponding relative motion signal, to the cloud. Upon authentication of the readings being synced, the primary device may delete or remove the readings and corresponding relative motion signal(s).

At step 320, data from a plurality of secondary devices is obtained. In some examples, the plurality of secondary devices may correspond to the one or more non-network communication devices 155, as described above with respect to FIG. 1. The plurality of secondary devices can include a networked CCTV, a networked access control system, or other closed-system devices operating within an environment. The plurality of secondary devices can include static devices, mobile devices, or a combination thereof. In some examples, each secondary device in the plurality of secondary devices may not include components for communicating or performing computations.

At step 330, a location corresponding to each of the plurality of secondary devices is determined with respect to the primary device. In some examples, the location may be computed using an inter-ranging distance calculation. For example, a distance between the primary device and one or more of the secondary devices may be estimated. In some examples, one or more of the secondary devices may have access to a server that detects an environment surrounding the secondary device using the primary device's fingerprint. For example, each secondary device within the plurality of secondary devices may estimate their position by detecting available wi-fi, Bluetooth, or network signals and comparing those signals to one that is identified in the primary device's fingerprint. The comparison can include detecting whether the wi-fi signal is the same between the primary device and the secondary device(s) and/or detecting a variation in signal strength of the wi-fi signal between the primary device and the secondary device(s).

Moreover, in some examples, a user may interact with a software, such as device software 180, to manually identify and record a position of one or more secondary devices surrounding them. For example, if one or more of the secondary devices are static assets, a user may walk to each static asset and tag the location of the asset, or point a camera at the environment where the static asset is located, using a digital device. In some examples, a user may tag the static assets using a device other than the primary device.

At step 340, a position of the primary device within an environment is computed. In some examples, a starting position of the primary device may be a known point of reference, or be determined using an accurate GPS signal, received in step 310. For example, the device software 180 may be initiated at a kiosk with location coordinates saved or accessible by the device software 180. Alternatively, in some examples, the starting position of the primary device may be unknown, therefore, contextual signals may be used to estimate the starting position. The estimated starting position may be calculated using data received from the accelerometer, gyroscope, magnetometer, a global navigation satellite system (GNSS) signal, GPS signal, barometer, or the like, obtained from the primary device. In some examples, the starting point may be referred to as the base location.

Once the base location is determined or estimated, the system may utilize the additional relative motion signals from the primary device to determine a velocity and orientation of the primary device with respect to the base location. In some examples, the system may input the relative motion signals and base location into a hybrid machine learning model using a sliding windowed approach. For example, the sliding windowed approach may divide a stream of data received into predefined window (i.e., 100 subsequent samples). Each division of data may then be analyzed individually by the hybrid machine learning model. The hybrid machine learning model may utilize one or more algorithms or models specific to different categories of relative motion signals, as described above (e.g., a motion AI model, a map AI model, a signal AI model, a view AI model etc.). The current position of the primary device may be determined using both the base position, as well as the determined velocity and orientation.

In some examples, the hybrid machine learning model may include a floor map algorithm to process floors, maps, and layouts of an environment, including one or more buildings/facilities in the environment. This algorithm may utilize the floor maps as a constraint to correct positional errors in the determinations of step 330. Moreover, the algorithm may identify locations of entrances, exits, elevators, stairs, etc. and input them into the hybrid machine learning model.

In some examples, the hybrid machine learning model may include a wireless signal algorithm to process light detection and ranging (LiDAR) signals, wi-fi signals, Bluetooth signals, cellular signals, or the like. The wireless signals may correspond to connections made by the primary device, as well as connection that are available to, but not yet initiated by the primary device. Signal strength, addresses, and other signatures associated with the wireless signals may be fused with the base location to enhance the position estimation of the primary device. For example, the wireless signal algorithm may cause the hybrid machine learning model to perform semantic matching of wi-fi names with existing two-dimensional maps to determine a location. In some examples, the wireless signal algorithm may not require pre-training.

In some examples, the hybrid machine learning model may include an algorithm for processing signals obtained by a static asset (i.e., when the plurality of secondary devices comprises one or more static assets). In some examples, static assets may include tables, painting fire hydrants, or other objects that are not mobile. The static assets may be manually captured by a user and matched with a location provided in a database of asset locations. For example, a user operating in a casino may be able identify their location based on specific tables in their surrounding environment.

In some examples, the hybrid machine learning model may include a video processing algorithm for processing visuals and audio obtained from secondary devices such as surveillance cameras, CCTV, or the like. For example, visual odometry may be performed to estimate the position and orientation of a video by matching it to known two-dimensional maps. The visual odometry may detect unique features of the video and compare them to points of interest on a map to link real-time data (obtained by the primary and secondary devices) to a known location.

At step 350, the computed position of the primary device within the environment is outputted. The velocity and orientation may also be outputted, to provide context of the primary device's movement. In some examples, the output may also indicate if a user controlling the primary device is standing, walking, running, moving floor levels, etc. In some examples, the output may be a JavaScript Object Notation (JSON) or a plurality of comma-separated values (CSV).

### Example Applications and Embodiments

Described below are example applications of the systems and methods described herein. It will be evident that various modifications may be made thereto without departing from the broader spirit and scope of implementations of the disclosure, as set forth in the claims. These examples are, accordingly, to be regarded in an illustrative sense rather than a restrictive sense.

The system and methods provided herein may allow personnel to determine and predict locations of individuals within a given environment with an accuracy rate of 0.3 to 3 meters, as well as historical incident data associated with each individual. In some examples, the localization system described above may be operated within a complex environment such as a casino. A casino environment can include multi-level structures, stairways, elevators, escalators, and narrow spaces. Moreover, a casino environment can include connected hotels, retail areas, food courts, parking garages, and/or underground tunnels. Moreover, in some examples, a casino may have various assets that emit sounds. For example, a water fountain or waterfall may emit sounds, therefore, allowing an audio signal to be correlated with location near the corresponding water fountain or waterfall.

In some examples, a casino may need to ensure that underage individuals are not present in designated gambling areas. Therefore, the localization system may monitor and track patrons to verify their identity, including their age. If it is predicted or detected that an underage individual will or has entered a designated gambling area, the system may output an alert to a security system.

Moreover, in some examples, a casino may track movement of money throughout various rooms and buildings. As the money moves to and from various gaming areas and secure locations, the localization system may send updates to casino personnel. For example, the localization system described herein may include a tracker or sensor attached to a money bag, money cart, lockbox, or the like. If the localization system detects the money has left a designated area, an alert may be sent to a security system, notifying personnel of the incident, as well as an updated location of the money.

In some examples, further complex environments such as airports may implement the systems and methods described herein. An airport can include multiple terminals, airline desks, security check points, informational booths, food courts, and retail environments. In some examples, airport security systems may instruct one or more security officers to locations throughout the airport. The localization system can be used to track and report the position of each security officer to effectively dispatch them to events of interest or incidents. In some examples, the location data may be provided to outside enforcements, such as local law enforcement, if forensic and postmodern analysis is needed. In further examples, the data may further be used in casinos or airports to track employees (e.g., custodial staff, security personnel, etc.) and ensure they are performing a duty or task correctly. For example, it may track movements to detect any anomalous behaviors.

In further examples, the systems and methods described herein may be implemented in complex environments such as multi-floor buildings (i.e., skyscrapers), environments comprising multiple buildings, environments with both indoor and outdoor spaces, multiple buildings connected via walkways, trams, or user travel by car, or the like. For example, environments may include hospitals, malls, train stations, bus stations, schools/universities, or the like.

In some examples, the localization system may be used to attract users to enter certain areas by enabling wayfinding and advertising to notify users of point of interests using an associated software system (i.e., device software 180). Moreover, in some examples, the localization system may provide a user with additional navigation features. For example, the associated software system may provide a user with an option to select a point of interest, or a nearby friend or family member, they would like to navigate to. The user interface may connect with devices nearby to accurately provide step-by-step instructions to the user based on their selection. In further examples, the localization system may be used for crowd management and detect anomalous crowd patterns.

The present disclosure has described one or more configurations, and it should be appreciated that many equivalents, alternatives, variations, and modifications, aside from those expressly stated, are possible and within the scope of the invention.

It is to be understood that the disclosure is not limited in its application to the details of construction and the arrangement of components set forth in the accompanying description or illustrated in the accompanying drawings. The disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular configurations or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or configurations. Further, references to particular rotational or other movements (e.g., counterclockwise rotation) is generally intended as a description only of movement relative a reference frame of a particular example of illustration.

In some configurations, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the disclosure can be implemented as a set of instructions, tangibly embodied on a non-transitory computer-readable media, such that a processor device can implement the instructions based upon reading the instructions from the computer-readable media. Some configurations of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular configurations of the disclosure. Further, in some configurations, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as configurations of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use configurations of the disclosure. Various modifications to the illustrated examples will be readily apparent to those skilled in the art, and the generic principles herein can be applied to other examples and applications without departing from the principles disclosed herein. Thus, configurations of the disclosure are not intended to be limited to configurations shown, but are to be accorded the widest scope consistent with the principles and features disclosed herein and the claims below. The accompanying detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Also as used herein, unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

What is claimed is:

1. A method of predicting a location of a primary device within an environment, the method comprising:
obtaining a relative motion signal from the primary device;
obtaining data from a plurality of non-network communication devices;
determining a location of each of the plurality of non-network communication devices with respect to the primary device;
computing, via a machine learning model, a position of the primary device within the environment based on the relative motion signal and the location of each of the plurality of non-network communication devices; and
outputting the computed position of the primary device within the environment.

2. The method of claim 1, wherein the relative motion signal determined by the primary device by:
collecting an inertial measurement and a contextual motion reading;
wherein the inertial measurement is collected using at least one of: a magnetometer, an accelerometer, a gyroscope, or a barometer; and
wherein the motion reading comprises at least one of a global positioning system (GPS) reading, a wi-fi signal, a cellular signal, or a camera signal.

3. The method of claim 1, further comprising:
determining a base location of the primary device; and
determining a velocity and orientation of the primary device based on the base location and the relative motion signal.

4. The method of claim 3, wherein computing the position of the primary device comprises inputting the relative motion signal and the base location into a hybrid machine learning model using a sliding windowed approach.

5. The method of claim 1, wherein determining the location of each of the plurality of non-network communication devices comprises detecting a variation in signal strength of a wi-fi signal between the primary device and the plurality of non-network communication devices.

6. A system for producing a location of a primary device within an environment, the system comprising:
a plurality of non-networked devices;
a processor;
an electronic controller connected to the processor, the electronic controller comprising a memory with instructions stored thereon that, when executed, cause the electronic controller to:
obtain data from the plurality of non-networked devices;
determine a location of each of the plurality of non-networked devices with respect to the primary device;
compute, via a machine learning model, a position of the primary device within the environment based on the data obtained from the plurality of non-networked devices and the location of each of the plurality of non-networked devices; and
output the computed position of the primary device within the environment.

7. The system of claim 6, wherein the plurality of non-networked devices comprises a closed-circuit television (CCTV) configured to capture real-time video of the environment.

8. The system of claim 6, wherein determining the location of each of the plurality of non-network communication devices comprises detecting a variation in signal strength of a wi-fi signal between the primary device and the plurality of non-network communication devices.

9. The system of claim 6, wherein the instructions further cause the electronic controller to:
receive, from the primary device, a relative motion signal,
wherein the position of the primary device is further computed based on the relative motion signal.

10. The system of claim 9, wherein the instructions further cause the electronic controller to:
determine a base location of the primary device; and
determine a velocity and orientation of the primary device based on the base location and the relative motion signal.

11. The system of claim 6, wherein the instructions further cause the electronic controller to:
collect an inertial measurement and a contextual motion reading;
wherein the inertial measurement is collected using at least one of: a magnetometer, an accelerometer, a gyroscope, or a barometer; and
wherein the motion reading comprises at least one of a global positioning system (GPS) reading, a wi-fi signal, a cellular signal, or a camera signal.

12. A system for localizing a device within a building complex, comprising:
a primary device comprising one or more relative motion sensors;
a plurality of non-network communication devices; and
a computing device configured to:
obtain a relative motion signal from the primary device;
obtain data from the plurality of non-network communication devices;
determine a location of each of the plurality of non-network communication devices with respect to the primary device; and
compute a position of the primary device within the building complex using the relative motion signal, the data from the plurality of non-network communication devices, and the determined locations of the plurality of non-network communication devices.

13. The system of claim 12, wherein the one or more relative motion sensors comprise at least one of an inertial measurement unit (IMU), a magnetometer, or a barometer.

14. The system of claim 12, wherein the primary device further comprises one or more contextual motion readings including at least one of a map, a global positioning system (GPS) signal, a wi-fi connection, a cellular connection, or a camera input.

15. The system of claim 12, wherein the plurality of non-network communication devices comprise at least one of a networked closed-circuit television (CCTV), a networked access control system, or one or more networked access points.

16. The system of claim 12, wherein the computing device is further configured to:
determine a base location of the primary device; and
determine a velocity and orientation of the primary device with respect to the base location.

17. The system of claim 16, wherein the computing device is further configured to access a machine learning model to compute the position of the primary device.
